(19) United States
(12) Patent Application Publication
(10) Pub. No.: US 2026/0245568 A1
(43) Pub. Date: Aug. 20, 2026

(54) FRAME SEGMENTATION AND GROUPING FOR AUDIO ENCODING

(71) Applicant: DOLBY LABORATORIES LICENSING CORPORATION

(72) Inventors: Grant A. Davidson, Burlingame, CA (US); Mark S. Vinton, Alameda, CA (US)

(73) Assignee: DOLBY LABORATORIES LICENSING CORPORATION, (US)

(21) Appl. No.: 19/164,548

(22) PCT Filed: Mar. 18, 2024
(86) PCT No.: PCT/US2024/020450

§ 371 Date: Sep. 11, 2025

Related U.S. Application Data
(60) Provisional application No. 63/491,839, filed on Mar. 23, 2023.
(60) Provisional application No. 63/560,563, filed on Mar. 1, 2024.

(51) Int. Cl. G10L 19/022; G10L 19/032

(52) U.S. Cl. CPC G10L 19/022; G10L 19/032

(57) ABSTRACT

Devices, systems and methods are described for encoding blocks of audio having content into frames. Example methods include receiving an input signal that includes blocks of audio information, The blocks of audio information include a set of block groups for a respective frame. Some methods include obtaining, for each respective block group, a first measure of quality, and obtaining, for each respective block group, a second measure of quality. The first measure of quality indicates a cost associated with a merge of two or more blocks of audio information to form the respective block group. The second measure of quality indicates an estimated distortion associated with a merge of the two or more blocks of audio information to form the respective block group. The methods include merging, based on the first measure of quality and the second measure of quality, at least two block groups to generate an encoded signal.

### CROSS REFERENCE TO RELATED APPLICATIONS

This application claims the benefit of priority of U.S. Provisional Application No. 63/560,563 filed on Mar. 1, 2024 and U.S. Provisional Application No. 63/491,839, filed on Mar. 23, 2024, all of which are incorporated herein by reference in their entirety.

### TECHNICAL FIELD

This application relates generally to audio and speech coding, and more specifically to transform and sub-band coding.

### BACKGROUND

Unless otherwise indicated herein, the materials described in this section are not prior art to the claims in this application, and are not admitted as prior art by inclusion in this section.

Many audio-processing systems operate by dividing streams of audio information into frames and further dividing the frames into blocks of sequential data representing a portion of the audio information in a particular time interval. Some type of signal processing is applied to each block in the stream. Examples of audio processing systems that apply a perceptual encoding process to each block are systems that conform to the Advanced Audio Coder (AAC) standard, which is described in ISO/IEC 13818-7. “MPEG-2 advanced audio coding, AAC”, International Standard, 1997; ISO/IEC JTCI/SC29, “Information technology—very low bitrate audio-visual coding,” and ISO/IEC IS-14496 (Part 3, Audio), 2019, and so-called AC-3 systems that conform to the coding standard described in the Advanced Television Systems Committee (ATSC) A/52A document entitled “Revision A to Digital Audio Compression (AC-3) Standard” published Aug. 20, 2001.

Many perceptual audio and speech codecs operate in the frequency domain, whereby segments of time-domain samples are transformed into sets of spectral coefficients (e.g., blocks). Each block is represented in the encoded bitstream by a set of spectral coefficients combined with some control parameters (e.g., side information). A set of one or more blocks are combined with the associated side information into individual frames. In most encoders, the number of bits allocated to spectral coefficients and to side information within each frame depends on characteristics of the input audio signal. The side information typically represents high-level information about the signal, while the spectral coefficients convey fine-grained information. For signals in which the high-level information does not change appreciably across one frame (e.g., short-term stationary signals), a low side information rate can be utilized. This allows more bits to be allocated to spectral coefficients, with a commensurate reduction in overall quantization noise compared to a time-invariant allocation scheme. For signals in which the high-level information changes significantly across one frame (e.g., short-term non-stationary signals), a relatively high side information rate is required to preserve temporal features.

The side information rate is typically controlled by partitioning each frame into one or more separate block groups. For example, in MPEG-4 AAC one frame can be comprised of one Modified Discrete Cosine Transform (MDCT) block of length 1024 or eight blocks of length 128. In the latter case, the eight blocks can be transmitted as eight separate groups of size one, as one large group of size eight, or any group arrangement in between. Each group includes associated side information, so as the number of groups increases the side information rate grows commensurately. The present disclosure recognizes various limitations in AAC. For example, the principal side information rate or cost in AAC is allocated to scale factor values. Because scale factors are shared across all blocks in a group, the addition of a new group will increase the side information rate by the amount of additional bits needed to represent the scale factors and associated information. For codecs operating at a constant bitrate, increased side information reduces the number of bits available for spectral coefficients. Hence, it is advantageous for audio encoders to carefully select the grouping of blocks to optimize the signal processing efficiency for every frame.

The only presently known fully-optimal solution is based on an Exhaustive Search method; however, this approach is computationally very intensive for the majority of coding applications. A Greedy Merge method is not as computationally demanding as Exhaustive Search and often may achieve near-optimal results. The present disclosure recognizes various limitations in prior implemented search methods. For example, a limitation of prior optimization methods is that distortion is defined only in terms of side information (e.g., scale factors or spectral envelope), for example, as described in U.S. Pat. No. 7,840,410, “Audio Coding Based on Block Grouping,” which is incorporated herein in its entirety. This type of method attempts to preserve the original spectral shape while reducing the amount of side information required. For example, cost metrics are expressed as a measure of error between the spectral coefficient log-energies from two separate groups of blocks and those from the candidate merged group. However, these prior methods for grouping do not account for changes in distortion due to spectral coefficient quantization. For a fixed number of spectral coefficient bits in one frame, merging two groups can at best preserve the same spectral coefficient quantization error as conveying them separately. However, in many merge scenarios the quantization error will increase. By observing spectral envelope energies only, prior-art methods only partially account for the effect that grouping decisions have on overall signal distortion at the decoder output.

It is with respect to these and other considerations that the disclosure made herein is presented.

### BRIEF SUMMARY OF THE DISCLOSURE

Techniques are described for processing audio signals. Various embodiments described herein provide a system and method for grouping and processing audio blocks based on both the side information bitrate and the changes in distortion due to coefficient quantization.

Devices, systems and methods are described for encoding blocks of audio having content into frames. Example methods include receiving an input signal that includes blocks of audio information, The blocks of audio information include a set of block groups for a respective frame. Some methods include obtaining, for each respective block group, a first measure of quality, and obtaining, for each respective block group, a second measure of quality. The first measure of quality indicates a cost associated with a merge of two or more blocks of audio information to form the respective block group. The second measure of quality indicates an estimated distortion associated with a merge of the two or more blocks of audio information to form the respective block group. The methods include merging, based on the first measure of quality and the second measure of quality, at least two block groups to generate an encoded signal.

According to an example embodiment, provided is a method to encode blocks of audio in frames, each frame includes a set of block groups, and each block includes content. The method includes receiving an input signal that includes the blocks of audio information. The blocks of audio information includes a set of block groups for a respective frame. The method includes obtaining, for each respective block group, a first measure of quality, and obtaining, for each respective block group, a second measure of quality. The first measure of quality indicates a cost associated with a merge of two or more blocks of audio information to form the respective block group. The second measure of quality indicates an estimated distortion associated with a merge of the two or more blocks of audio information to form the respective block group. The method includes merging, based on the first measure of quality and the second measure of quality, at least two block groups of the set of block groups to generate an encoded signal that represents contents of the input signal and associated control parameters for each block group in the set, and outputting the encoded signal.

According to another example embodiment, provided is an apparatus to process blocks of audio information arranged in frames. The apparatus includes an electronic processor configured to receive an input signal that includes the blocks of audio information. The blocks of audio information includes a set of block groups for a respective frame. The electronic processor is configured to obtain, for each respective block group, a first measure of quality and obtain, for each respective block group, a second measure of quality. The first measure of quality indicates a cost associated with a merge of two or more blocks of audio information to form the respective block group. The second measure of quality indicates an estimated distortion associated with a merge of the two or more blocks of audio information to form the respective block group. The electronic processor is configured to merge, based on the first measure of quality and the second measure of quality, at least two block groups of the set of block groups to generate an encoded signal that represents contents of the input signal and associated control parameters for each block group in the set, and output the encoded signal.

According to still another example embodiment, provided is a non-transitory computer-readable storage medium recording a program of instructions that is executable by a device to perform a method to process blocks of audio information arranged in frames. The method includes receiving an input signal that includes the blocks of audio information. The blocks of audio information include a set of block groups for a respective frame. The method includes obtaining, for each respective block group, a first measure of quality, and obtaining, for each respective block group, a second measure of quality. The first measure of quality indicates a cost associated with a merge of two or more blocks of audio information to form the respective block group. The second measure of quality indicates an estimated distortion associated with a merge of the two or more blocks of audio information to form the respective block group. The method includes merging, based on the first measure of quality and the second measure of quality, at least two block groups of the set of block groups to generate an encoded signal that represents contents of the input signal and associated control parameters for each block group in the set, and outputting the encoded signal.

According to yet another example embodiment, provided is a method to encode blocks of audio in frames. The method includes receiving an input signal that includes a set of block groups in a frame, where each block includes content. In a first loop, the method includes selecting each block group from the set of block groups, in turn, as a selected first block group for a potential merge. In a second loop, the method includes selecting each block group from the set of block groups different from the first block group, in turn, as a selected second block group for the potential merge, obtaining a first measure of quality associated with a merge of the selected first block group with the selected second block group, obtaining a second measure of quality associated with the merge of the selected first block group with the selected second block group, and comparing the first measure of quality and the second measure of quality of the second block group to prior iterations of the second loop to selectively identify the second block group as a merge candidate block. The method includes, after the second loop has completed all iterations, selectively merging the selected first block group with the identified merge candidate block, and assembling the frame as an encoded signal and outputting the encoded signal.

According to a further example embodiment, provided is an apparatus to encode blocks of audio information arranged in frames, where each frame includes a set of block groups, and where each block includes content. The apparatus includes an electronic processor configured to perform operations of a method including receiving an input signal that includes a set of block groups in a frame, where each block includes content. In a first loop, the method includes selecting each block group from the set of block groups, in turn, as a selected first block group for a potential merge. In a second loop, the method includes selecting each block group from the set of block groups different from the first block group, in turn, as a selected second block group for the potential merge, obtaining a first measure of quality associated with a merge of the selected first block group with the selected second block group, obtaining a second measure of quality associated with the merge of the selected first block group with the selected second block group, and comparing the first measure of quality and the second measure of quality of the second block group to prior iterations of the second loop to selectively identify the second block group as a merge candidate block. The method includes, after the second loop has completed all iterations, selectively merging the selected first block group with the identified merge candidate block, and assembling the frame as an encoded signal and outputting the encoded signal.

According to a still further example embodiment, provided is a non-transitory computer-readable storage medium recording a program of instructions that is executable by a device to perform a method including receiving an input signal that includes a set of block groups in a frame, where each block includes content. In a first loop, the method includes selecting each block group from the set of block groups, in turn, as a selected first block group for a potential merge. In a second loop, the method includes selecting each block group from the set of block groups different from the first block group, in turn, as a selected second block group for the potential merge, obtaining a first measure of quality associated with a merge of the selected first block group with the selected second block group, obtaining a second measure of quality associated with the merge of the selected first block group with the selected second block group, and comparing the first measure of quality and the second measure of quality of the second block group to prior iterations of the second loop to selectively identify the second block group as a merge candidate block. The method includes, after the second loop has completed all iterations, selectively merging the selected first block group with the identified merge candidate block, and assembling the frame as an encoded signal and outputting the encoded signal.

In some examples, methods for encoding blocks of audio in frames include receiving an input signal including the blocks of audio information and merging sets of blocks of audio information based on (i) a cost associated with merging two or more blocks of audio information and (ii) an estimated distortion resulting from merging the two or more blocks of audio information.

In some additional examples, the cost associated with merging two or more blocks of audio information and/or an estimated distortion resulting from merging the two or more blocks of audio information are determined based on weighted dB costs of the two or more blocks. The weighted dB costs are implemented to identify whether merging the two or more blocks is advantageous (e.g., cost-efficient) compared to not merging the two or more blocks. The weighted dB costs may be based on an average power level of each scale factor band and the per-block power levels of the blocks of audio information.

In some other examples, the cost associated with merging two or more blocks of audio information and/or an estimated distortion resulting from merging the two or more blocks of audio information are determined based on the bit cost to send the blocks of audio information calculated using perceptual entropy.

In some further examples, merging the two or more blocks of audio information includes merging adjacent blocks. The blocks of audio information may comprise time-domain samples of audio information, frequency-domain coefficients of audio information, or a combination thereof.

In this manner, various aspects of the present disclosure provide for processing of audio blocks, and effect improvements in at least the technical fields of audio encoding, audio decoding, and the like.

The embodiments described herein may be generally described as techniques, where the term “technique” may refer to system(s), device(s), method(s), computer-readable instruction(s), module(s), component(s), hardware logic, and/or operation(s) as suggested by the context as applied herein.

Features and technical benefits other than those explicitly described above will be apparent from a reading of the following Detailed Description and a review of the associate drawings. This Summary is provided to introduce a selection of techniques in a simplified form, and not intended to identify key or essential features of the claimed subject matter, which are defined by the appended claims.

### DESCRIPTION OF THE DRAWINGS

These and other more detailed and specific features of various embodiments are more fully disclosed in the following description, reference being had to the accompanying drawings, in which:

FIG. 1 illustrates a block diagram of an example audio coding system in which various aspects of the present invention may be incorporated.

FIG. 2A illustrates a block diagram of an example electronic device architecture suitable for implementing various aspects of the present invention.

FIG. 2B illustrates a schematic block diagram of an example CPU implemented in the device architecture of FIG. 2A that may be used to implement various aspects of the present disclosure.

FIG. 3 illustrates a flow chart of various example methods for merging blocks based on measures of quality.

FIG. 4 illustrates a flow chart of some example methods for merging blocks based on the 6 dB/bit estimation rule.

FIG. 5 illustrates a flow chart of example methods for merging blocks based on perceptual entropy.

FIG. 6 illustrates a block diagram that illustrates an example of a Greedy Merge process applied to four blocks, according to various aspects of the present invention.

FIG. 7 illustrates a flow chart of example methods performed by a decoding device, in accordance with various aspects of the present invention.

### DETAILED DESCRIPTION

In the following description, numerous details are set forth, such as audio device configurations, timings, operations, and the like, in order to provide an understanding of one or more aspects of the present disclosure. It will be readily apparent to one skilled in the art that these specific details are merely examples and not intended to limit the scope of this application.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting, or deriving. In addition, in the following description and claims, unless defined otherwise, all technical and scientific terms used herein have the same meaning as commonly understood by one of ordinary skills in the art to which this disclosure belongs.

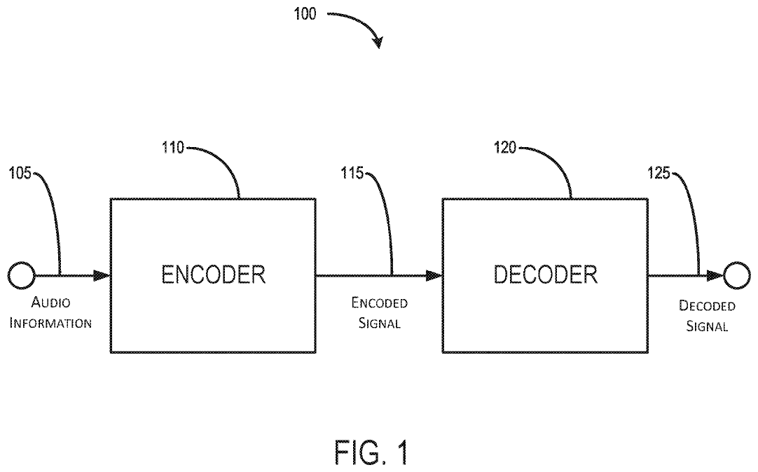

FIG. 1 illustrates a block diagram of an example audio coding system 100 in which various aspects of the present invention may be incorporated. The example audio coding system 100 includes an encoder 110 and a decoder 120. The input of the encoder 100 corresponds to a first signal path 105, while an output of the encoder 100 corresponds to a second signal path 115. The input of the decoder 120 corresponds to the second signal path 115, while an output of the decoder 125 corresponds to a third signal path 125.

The encoder 110 is configured to receive, from the first signal path 105, one or more streams of audio information representing one or more channels of audio signals. The encoder 110 is further configured to process the streams of audio information to generate an encoded signal, which may be output to the second signal path 115. At the second signal path 115, the encoded signal may be stored (e.g., captured, buffered and/or recorded), or transmitted (e.g., via a wired or wireless communication medium). The decoder 120 is configured to receive the encoded signal from the second signal path 115. The decoder 120 is further configured to process the encoded signal and generate a decoded signal, which may be output to the third signal path 125. The decoded signal that is generated by the decoder 120 corresponds to a replica of the audio information previously received by the encoder 110 from the first signal path 105. At the third signal path, the decoded signal may be stored (e.g., captured and/or recorded), transmitted (e.g., via a wireless or wired electronic communication medium), or output to a listening device (e.g., an audio processing device such as a receiver, speaker, soundbar, etc.).

In various examples described herein, the terms “replica” and “replica signal” are not intended to mean that the streams of audio information are “identical”. Instead, the term “replica” may indicate that the streams of audio information are approximately the same as the original audio information. For example, when the encoder 110 uses a lossless encoding technique to generate the encoded signal, the decoder 120 can in principle recover a lossless version that is approximately the same as the original audio information from the streams.

However, in examples where the encoder 110 uses a lossy encoding technique, such as for perceptual coding, the content of the recovered replica signal is generally not identical to the content of the original stream but it may be perceptually indistinguishable from the original content. Thus, the terms “replica” and “replica signal” are intended to cover both lossless and lossy encoding techniques as used herein.

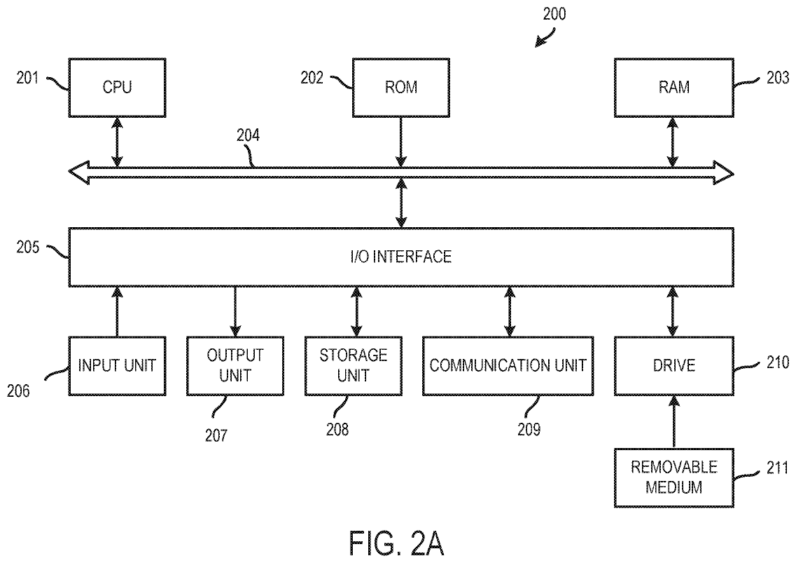

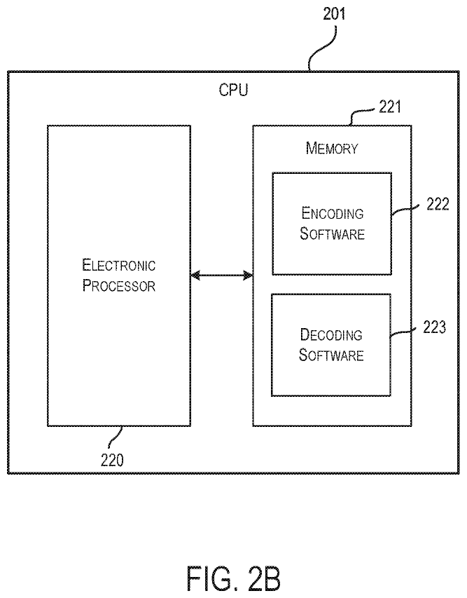

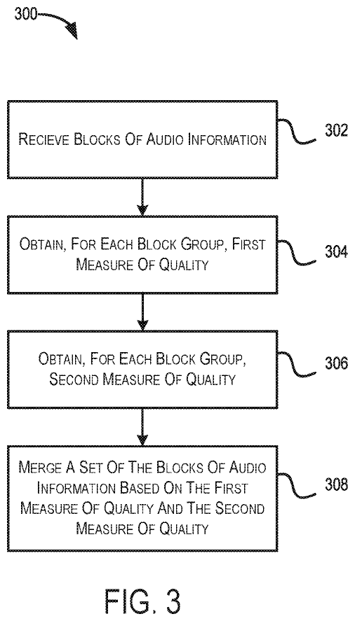

FIG. 2A shows a block diagram of an example electronic device architecture 200 (e.g., an apparatus 200) suitable for implementing various aspects of the present disclosure. Architecture 200 includes but is not limited to servers and client devices, systems, and methods as will be described in reference to FIGS. 3-5. As shown, the architecture 200 includes central processing unit (CPU) 201 which is capable of performing various processes in accordance with a program stored in, for example, read only memory (ROM) 202 or a program loaded from, for example, storage unit 208 to random access memory (RAM) 203. The CPU 201 may be, for example, an electronic processor 201. In RAM 203, the data required when CPU 201 performs the various processes is also stored, as required. CPU 201, ROM 202 and RAM 203 are connected to one another via bus 204. The CPU 201 may perform instructions stored by the ROM 202, the RAM 203, or both to perform the methods described herein related to frame segmentation and encoding and decoding of data. Input/output (I/O) interface 205 is also connected to bus 204.

The following components are connected to I/O interface 205: input unit 206, that may include a keyboard, a mouse, or the like; output unit 207 that may include a display such as a liquid crystal display (LCD) and one or more speakers; storage unit 208 including a hard disk, or another suitable storage device; and communication unit 209 including a network interface card such as a network card (e.g., wired or wireless).

In some implementations, input unit 206 includes one or more microphones in different positions (depending on the host device) enabling capture of audio signals in various formats (e.g., mono, stereo, spatial, immersive, and other suitable formats).

In some implementations, output unit 207 include systems with various number of speakers. Output unit 207 (depending on the capabilities of the host device) can render audio signals in various formats (e.g., mono, stereo, immersive, binaural, and other suitable formats).

In some embodiments, communication unit 209 is configured to communicate with other devices (e.g., via a network). Drive 210 is also connected to I/O interface 205, as required. Removable medium 211, such as a magnetic disk, an optical disk, a magneto-optical disk, a flash drive or another suitable removable medium is mounted on drive 210, so that a computer program read therefrom is installed into storage unit 208, as required. A person skilled in the art would understand that although apparatus 200 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 209, and/or installed from the removable medium 211, as shown in FIG. 2A.

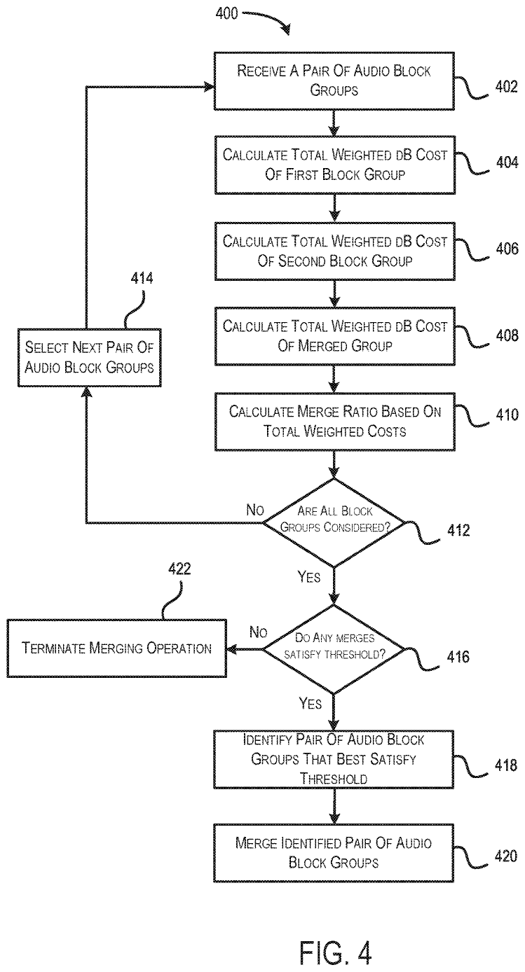

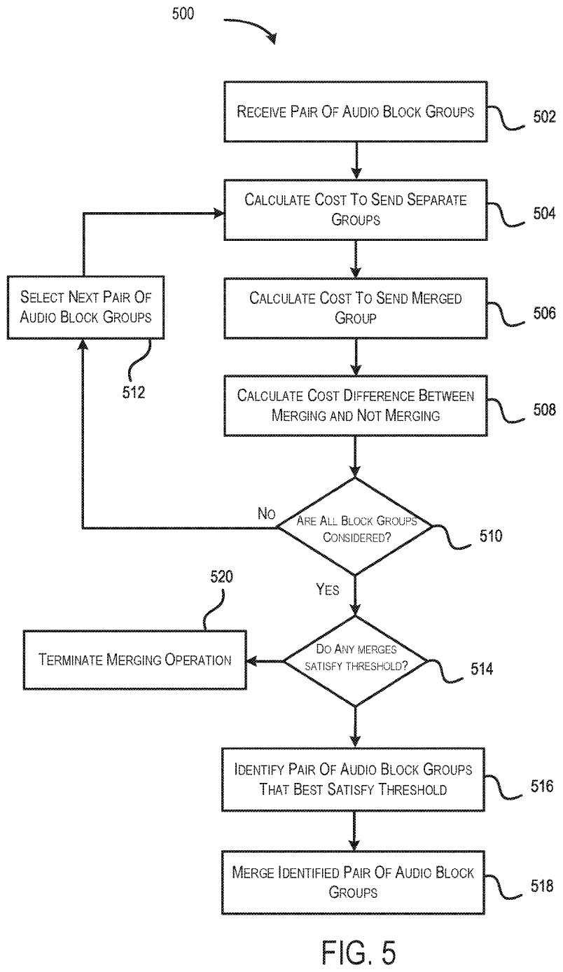

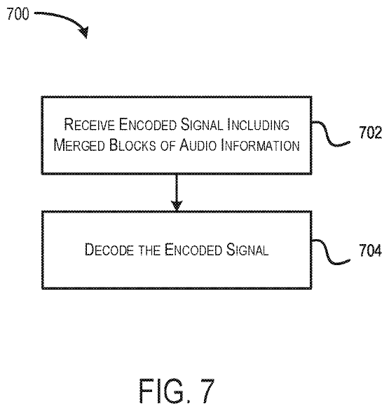

FIG. 2B illustrates a schematic block diagram of an example CPU 201 implemented in the device architecture 200 of FIG. 2A that may be used to implement various aspects of the present disclosure. The CPU 201 includes an electronic processor 220 and a memory 221. The electronic processor 220 is electrically and/or communicatively connected to the memory 221 for bidirectional communication. The memory 221 stores encoding software 222 and/or decoding software 223. In some examples, memory 221 may be located internal to the electronic processor 220, such as for an internal cache memory or some other internally located ROM, RAM, or flash memory. In other examples, memory 221 may be located, for example, in a ROM 202, a RAM 203, flash memory or a removable medium 211, or another non-transitory computer readable medium that is contemplated for device architecture 200. In some instances, the electronic processor 220 may implement the encoding software 222 stored in the memory 221 to perform, among other things, the methods 300 of FIG. 3, the methods 400 of FIG. 4, and/or the methods 500 of FIG. 5. Additionally, the electronic processor 220 may implement the decoding software 223 stored in the memory 221 to perform, among other things, the method 700 of FIG. 7.

Generally, various example embodiments of the present disclosure may be implemented in hardware or special purpose circuits (e.g., control circuitry), software, logic or any combination thereof. For example, the units discussed above can be executed by control circuitry (e.g., CPU 201 in combination with other components of FIG. 2A), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

Embodiments described herein perform frame segmentation by jointly considering the effects of grouping based on both side information cost and distortion due to spectral coefficient quantization. Metrics are developed for both forms of cost and are typically expressed in units of bits. For a given pair of adjacent groups that are candidates for merging, the number of side information bits saved due to merging is compared with the number of bits lost in spectral coefficient quantization. If the number of bits saved is larger than the number of bits lost, the corresponding adjacent groups may be merged with a net reduction in quantization distortion.

Embodiments described herein may be implemented with any cost-based search method for finding a grouping solution. These cost-based search methods include the Exhaustive Search Method, the Greedy Merge Method, and the Fast Optimal Method. As one example, the Greedy Merge method begins with each block in one frame represented by its own side information, and then iteratively combines blocks into groups that minimize a suitable cost metric. In each iterative step, the cost of merging every adjacent pair of groups is compared with the cost of leaving them separate. The group pair having the most favorable cost is merged into one group.

This iterative process continues until no adjacent groups can be combined to produce a more optimal solution.

In some implementations, the side information is primarily comprised of scale factors, also referred to as spectral envelope data for AC-3 and a split-rendering codec. The scale factors may be derived from a perceptual masking threshold in the context of MPEG AAC. However, other forms of side information may also be used in perceptual audio codecs, such as Huffman codebook assignments and sectioning information, as described by M. Bosi et al., “ISO/IEC MPEG-2 Advanced Audio Coding”, J. Audio Eng. Soc., Vol. 45, No. 10, October 1997. Side information cost may be computed by the encoder 110 using conventional bit counting means. Alternatively, the side information cost may be estimated using long-term average values for scale factor, Huffman codebook, and sectioning data.

FIG. 3 illustrates a flow chart of various example methods 300 for merging blocks based on measures of quality. The example methods 300 may be performed by a processor such as, for example, CPU 201, which may be configured to perform methods 300 via machine-executable instructions. The example methods 300 may be broken into various blocks or partitions, such as blocks 302, 304, 306 and 308. The various process blocks illustrated in FIG. 3 provide examples of various methods disclosed herein, and it is understood that some blocks may be removed, added, combined, or modified without departing from the spirit of the present disclosure. For some examples, processing of the various blocks, which may be described as processes, methods, steps, blocks, operations, or functions, may commence at block 302.

At block 302, “Receive Blocks of Audio Information”, the CPU 201 receives (blocks of audio information. The blocks of audio information are arranged in frames. In some embodiments, each block of audio information includes content representing a respective time interval of audio information. Additionally, the blocks may comprise time-domain samples of audio information, frequency-domain coefficients of audio information, or a combination thereof. Processing may continue from block 302 to block 304.

At block 304, “Obtain, For Each Block Group, a First Measure of Quality”, the CPU 201 obtains, for each block group, a first measure of quality. For example, the CPU 201 may obtain a first measure of quality as a measure of side information cost for each possible block group that may be formed by merging various blocks of audio information. The measure of side information cost may be obtained or determined, for example, via estimation(s), calculation(s) or other methods as will be described further below in more detail. Processing may continue from block 304 to block 306.

At block 306, “Obtain, For Each Block Group, a Second Measure of Quality”, the CPU 201 obtains, for each block group, a second measure of quality. For example, the CPU 201 may obtain a second measure quality as a measure of distortion due to spectral coefficient quantization for each possible block group. The measure of distortion may be obtained or determined, for example, via estimation(s), calculation(s) or other methods as will be described further below in more detail. Processing may continue from block 306 to block 308.

At block 308, “Merge a Set of the Blocks of Audio Information Based on the First Measure of Quality and the Second Measure of Quality”, the CPU 201 merges a set of the blocks of audio information based on the first measure of quality and the second measure of quality. For example, the CPU 201 may iteratively process the first measure of quality and the second measure of quality for each possible block group that may be formed and selectively merge the blocks of audio information that results in reduced cost while limiting distortion. In some instances, a set of block groups includes at least two block groups. In other instances, a set of block groups may include at least one block group, at least three block groups, at least four block groups, and the like.

In some implementations, the measure of distortion is related to changes in allocated spectral coefficient bits using a 6 dB per bit rule. For example, if in a particular band containing bₖ spectral coefficients the scale factor increases by 3 dB due to merging (relative to coding the block separately), the number of bits lost is approximately 3bₖ/6. The resulting distortion in this band will increase. Alternatively, if the scale factor decreases by 4 dB due to merging, the number of bits gained relative to coding the block separately is 4bₖ/6. In this case, the allocation gain may be viewed as an over-coding of spectral coefficients.

FIG. 4 illustrates a flow chart of some example methods 400 for merging blocks based on the 6 dB/bit estimation rule. The example methods 400 may be performed by a processor such as, for example, CPU 201, which may be configured to perform methods 400 via machine-executable instructions. The example methods 400 may be broken into various blocks or partitions, such as blocks 402, 404, 406, 408, 410, 412, and 414. The various process blocks illustrated in FIG. 4 provide examples of various methods disclosed herein, and it is understood that some blocks may be removed, added, combined, or modified without departing from the spirit of the present disclosure. For some examples, processing of the various blocks, which may be described as processes, methods, steps, blocks, operations, or functions, may commence at block 402.

At block 402, “Receive Pair of Audio Block Groups”, the CPU 201 receives a pair of block groups. For example, a plurality of blocks of audio information are received. The blocks of audio information form block groups, with at least one audio block within each block group. The CPU 201 considers a first block group and a second block group for merging. In some implementations, the first block group and the second block group are adjacent block groups. The first block group includes N1 blocks, and a merged group (e.g., the group formed by merging or combining the first block group and the second block group) includes N blocks. Each block of audio information includes K scalefactor bands per block. Processing may continue from block 402 to block 404.

At block 404, “Calculate Total Weighted dB Cost of First Block Group”, the CPU 201 calculates a total weighted dB cost of the first block group relative to not creating the merged group. For example, Equation 1 provides for calculating a first total weighted cost C1:

$$C 1 = {\sum }_{n = 1}^{N 1} {\sum }_{k = 1}^{K} {w}_{n k} {b}_{k} \vert {P}_{k}^{1} - {S}_{n k} \vert \qquad [ Equation 1 ]$$

$$where :$$

$${S}_{n k} = 10 * {log}_{10} ( {s}_{n k} )$$

$${P}_{k}^{1} = 10 * {log}_{10} ( \frac{1}{N 1} {\sum }_{n = 1}^{N 1} {s}_{n k} )$$

and where:
wₙₖ=a per-scalefactor subjective importance weight between 0 and 1;
bₖ=number of spectral coefficients in the k^{th} band; and
Sₙₖ=per-block power-domain scale factor for the n^{th} block and the k^{th} band.
   Processing may continue from block 404 to block 406.

At block 406, “Calculate Total Weighted dB Cost of Second Block Group”, the CPU 201 calculates a total weighted dB cost of the second block group relative to not creating the merged group. For example, Equation 2 provides for calculating a second total weighted cost C2:

$$C 2 = {\sum }_{n = N 1 + 1}^{N} {\sum }_{k = 1}^{K} {w}_{n k} {b}_{k} \vert {P}_{k}^{2} - {S}_{n k} \vert \qquad [ Equation 2 ]$$

$$where :$$

$${P}_{k}^{2} = 10 * {log}_{10} ( \frac{1}{N - N 1} {\sum }_{n = N 1 + 1}^{N} {s}_{n k} ) .$$

Processing may continue from block 406 to block 408.

At block 408, “Calculate Total Weighted dB Cost of Merged Group”, the CPU 201 calculates a total weighted dB cost of the merged group relative to not creating the merged group. For example, Equation 3 provides for calculating a merged total weighted cost C:

$$C = {\sum }_{n = 1}^{N} {\sum }_{k = 1}^{K} {w}_{n k} {b}_{k} \vert {P}_{k} - {S}_{n k} \vert \qquad [ Equation 3 ]$$

$$where :$$

$${P}_{k} = 10 * {log}_{10} ( \frac{1}{N} {\sum }_{n = 1}^{N} {s}_{n k} ) .$$

Processing may continue from block 408 to block 410.

At block 410, “Calculate Merge Ratio Based On Total Weighted Costs”, the CPU 201 calculates a merge ratio based on the total weighted dB costs (e.g., based on the calculated first total weighted dB cost, the calculated second total weighted dB cost, and the calculated merged total weighted dB cost). For example, the CPU 201 calculates a merge ratio R, which represents an estimated number of spectral bits lost when merging divided by the side information bits saved, as shown in Equation 4:

$$R = \frac{C - ( C 1 + C 2 )}{6.02 * {b}_{SI} * K} \qquad [ Equation 4 ]$$

where:
b_{SI}=average number of bits per band to convey side information.

In the merge ratio R, the component

$$\frac{C - ( C 1 + C 2 )}{6.02}$$

provides an estimate of the number of bits “lost” when merging, including spectral coefficients that are both under and over allocated as a result of the merge. The component b_{SI}*K provides the average number of bits saved during the candidate merge. Processing may continue from block 410 to block 412.

At block 412, “Are All Block Groups Considered,” the CPU 201 determines whether all block groups included in the plurality of blocks of audio information have been considered. Particularly, the CPU 201 determines whether the merge ratio has been calculated for all block groups that may be merged. When all block groups have not been considered, processing proceeds from block 412 to block 414 and the CPU 201 selects the next pair of audio block groups. Processing may then return to block 404 from block 414 and the CPU 201 proceeds to calculate the merge ratio for the new block group.

When all block groups included in the plurality of blocks of audio information have been considered, processing proceeds from block 412 to block 416. At block 416, “Do Any Merges Satisfy Threshold,” the CPU 201 determines whether any merges of block groups satisfies a threshold value. For example, the CPU 201 compares the calculated merge ratio of each pair of audio block groups to a threshold value. For example, when the calculated merge ratio is below the threshold value to satisfy the threshold value, the pair of audio block groups associated with the calculated merge ratio with the lowest value are identified. In another example, when the calculated merge ratio is above the threshold value to satisfy the threshold value, the pair of audio block groups associated with the calculated merge ratio with the highest value are identified.

In some examples, the threshold value may be 1. When the merge ratio R is less than 1, merging the first block group and the second block group into a merged group is considered to be more favorable than encoding the first block group and the second block group separately. When the merge ratio R is greater than or equal 1, merging the first block group and the second block group into a merged group is considered to be unfavorable, and the first block group and the second block group are kept as separate groups.

The numerator may be non-negative, as a merged set of scale factors yields higher quantizer precision loss than two separate groups. The weights wₙₖ may be computed, for example, based on sensation-level masking effects such that spectral components that are subjectively louder than other components make a larger contribution to the total cost than less significant ones. Further details on sensation-level masking effects are described in U.S. Patent Publication No. 2022/0415334, “A Psychoacoustic Model for Audio Processing,” incorporated herein by reference in its entirety.

When at least one merge satisfies the threshold, processing may continue from block 416 to block 418. At block 418, “Identify Block Groups That Best Satisfy Threshold”, the CPU 201 identifies which block groups best satisfy a threshold value. For example, in situations where the CPU determines whether the calculated merge ratio R is less than 1, the CPU 201 identifies which pair of audio block groups has a calculated merge ratio R that is the “most less” than 1. In another example, in situations where the CPU determines whether the calculated merge ratio R is greater than 1, the CPU 201 identifies which pair of audio block groups has a calculated merge ratio R that is the “most greater” than 1. Processing may continue from block 418 to block 420. At block 420, “Merge Identified First And Second Block Groups”, the CPU 201 merges the identified first and second block groups that were identified at block 418.

In another instance, the CPU 201 calculates a merge difference value S that provides a difference between bits “lost” and bits saved by merging, as provided by Equation 5:

$$S = \frac{C - ( C 1 + C 2 )}{6.02} - {b}_{SI} * K \qquad [ Equation 5 ]$$

In such an instance, the CPU 201 merges the first block group and the second block group when S is less than 0.

A variant of estimating the spectral coefficient bit lost using a 6 dB per bit rule is based on a backward-adaptive bit allocation scheme, such as that described by G. Davidson et al., “Parametric Bit Allocation in a Perceptual Audio Coder,” 97^{th} AES Convention, San Francisco, November 1994. In this instance, the scale factors represent a spectral envelope (e.g., banded RMS or peak signal energy). Additionally, if the bit allocation is derived based on sensation-level masking, two counteracting factors affect the bit loss estimates. As described above, when the spectral envelope increases, the estimated number of spectral coefficient bits drops. Alternatively, a masking threshold derived using a sensation level rule from the raised envelope will increase the estimated number of spectral coefficient bits. The effects of both changes can be combined to estimate the net change in estimated spectral bits.

In the example of a backward-adaptive codec based on sensation-level masking, the absolute value operator for first total weighted cost C1, second total weighted cost C2, and C may be adjusted to account for the counteracting effect of sensation-level masking. Furthermore, the average side information difference estimate b_{SI}*K may be replaced with actual bit count differences to increase accuracy. For example, the b_{SI}*K term may be replaced with a value corresponding to the difference between the side information bit counts of the two groups separately and the merged group, as shown in Equation 6:

$$S = \frac{C - ( C 1 + C 2 )}{6.02} - ( ( {B}_{1} + {B}_{2} ) - {B}_{M} ) \qquad [ Equation 6 ]$$

where B₁, B₂, and B_{M} represent actual side information bit counts for the first, second, and merged groups, respectively.

Referring again to block 416, in some instances, none of the calculated merge ratios satisfy the threshold value. In such an instance, processing may proceed from block 416 to block 422. At block 422, “Terminate Merging Operation,” the CPU 201 terminates the merging operation and none of the audio block groups are merged. Various example methods 400 may continue until none of the calculated merge ratios satisfy the threshold value. For example, once the merging occurs, the process of considering each possible merge group and merging the adjacent groups that yield the largest improvement is continued until no two adjacent groups can be merged to yield an improvement in coding accuracy. As there may be multiple candidates that satisfy the threshold value, considering each group before performing a merge provides for merging the groups resulting in the greatest amount of improvement.

Another example for estimating spectral coefficient bits lost during a group merge is based on perceptual entropy. In some encoders, such as MPEG-4 AAC and Dolby AC-4, the scale factors are derived from an estimate of the noise masking threshold. The noise masking threshold may be used to estimate the number of bits required to convey the spectral coefficients from each block in a perceptually transparent manner (e.g., perceptual entropy). The estimated number of bits lost following a merge operation is then derived based on accumulated per-band differences between the perceptual entropy and the actual number of bits utilized.

FIG. 5 illustrates a flow chart of example methods 500 for merging blocks based on perceptual entropy. The example methods 500 may be performed by a processor such as, for example, CPU 201, which may be configured to perform methods 500 via machine-executable instructions. The example methods 500 may be broken into various blocks or partitions, such as blocks 502, 504, 506, 508, 510, 512, and 514. The various process blocks illustrated in FIG. 5 provide examples of various methods disclosed herein, and it is understood that some blocks may be removed, added, combined, or modified without departing from the spirit of the present disclosure. For some examples, processing of the various blocks, which may be described as processes, methods, steps, blocks, operations, or functions, may commence at block 502.

At block 502, “Receive Pair of Audio Block Groups”, the CPU 201 receives a pair of audio block groups. For example, a plurality of blocks of audio information are received. The blocks of audio information form block groups, with at least one audio block within each block group. The CPU 201 considers a first block group and a second block group for merging. In some implementations, the first block group and the second block group are adjacent block groups. The first block group includes N1 blocks, and a merged group (e.g., the group formed by merging or combining the first block group and the second block group) includes N blocks.

Each block of audio information includes K scalefactor bands per block. Processing may continue from block 502 to block 504.

At block 504, “Calculate Cost to Send Separate Groups”, the CPU 201 calculates the cost to send the first block group and the second block group separately. For example, the CPU 201 calculates the cost Cs in bits to send separate groups relative to a baseline condition, as provided by Equation 7:

$${C}_{s} = {\sum }_{n = 1}^{{N}_{1}} {\sum }_{k = 1}^{K} \vert G {1}_{n k} - P {E}_{n k} \vert + {\sum }_{n = {N}_{1} + 1}^{N} {\sum }_{k = 1}^{K} \vert G {2}_{n k} - P {E}_{n k} \vert + {B}_{1} + {B}_{2} \qquad [ Equation 7 ]$$

where:
PEₙₖ=baseline perceptual entropy for the n^{th} block and the k^{th} band (each block coded using its own scalefactors);
G1ₙₖ=spectral coefficient bit count estimate for the n^{th} block and the k^{th} band in a 1^{st} group; and
G2ₙₖ=spectral coefficient bit count estimate for the n^{th} block and the k^{th} band in a 2^{nd} group.
   Processing may continue from block 504 to block 506.

At block 506, “Calculate Cost to Send Merged Group”, the CPU 201 calculates the cost to send the first block group and the second block group as a merged group. For example, the CPU 201 calculates the cost Cm in bits to send a merged group relative to a baseline condition, as provided in Equation 8:

$${C}_{m} = {\sum }_{n = 1}^{N} {\sum }_{k = 1}^{K} \vert {M}_{n k} - P {E}_{nk} \vert + {B}_{M} \qquad [ Equation 8 ]$$

where:
Mₙₖ=spectral coefficient bit count estimate for the n^{th} block and the k^{th} band in the merged group.
   Processing may continue from block 506 to block 508.

At block 508, “Calculate Cost Difference Between Merging and Not Merging”, the CPU 201 calculates the cost difference between merging and not merging the pair of audio blocks. For example, the CPU 201 calculates the difference between the cost Cm and the cost Cs, as provided by Equation 9:

$$C = {C}_{m} - {C}_{s} \qquad [ Equation 9 ]$$

Processing may continue from block 508 to block 510.

At block 510, “Are All Block Groups Considered?”, the CPU 201 determines whether all block groups included in the plurality of blocks of audio information have been considered. Particularly, the CPU 201 determines whether the cost difference has been calculated for all block groups that may be merged. When all block groups have not been considered, processing may proceed from block 510 to block 512. At block 512, “Select Next Pair Of Audio Block Groups,” the CPU 201 selects the next pair of audio block groups. Processing may then return to block 504 and the CPU 201 proceeds to calculate the cost difference for the new block group.

When all block groups included in the plurality of blocks of audio information have been considered, processing may proceed from block 510 to block 514. At block 514, “Do Any Merges Satisfy Threshold,” the CPU 201 determines whether any merges satisfy a threshold. For example, the CPU 201 compares the calculated cost difference of each pair of audio block groups to a threshold value. For example, when the calculated cost difference is below the threshold value to satisfy the threshold value, the pair of audio block groups associated with the cost difference with the lowest value are identified. In another example, when the calculated cost difference is above the threshold value to satisfy the threshold value, the pair of audio block groups associated with the cost difference with the highest value are identified.

In some implementations, the threshold is 0. When the cost difference C is less than 0, the merge is considered favorable and the CPU 201 identifies the first block group and the second block group as candidates to generate the merged group. When the cost difference C is greater than or equal to 0, the CPU 201 does not merge the first block group and the second block group.

Processing may continue from block 514 to block 516. At block 516, “Identify Pair Of Audio Block Groups That Best Satisfy Threshold,” the CPU 201 identifies which block groups best satisfy a threshold value. For example, when the threshold is 0, the CPU 201 identifies which pair of audio block groups are “most less” than 0. Processing may continue from block 516 to block 518. At block 518, “Merge Identified First And Second Block Groups”, the CPU 201 merges the identified first and second block groups that were identified at block 516.

Referring again to block 514, in some instances, none of the calculated merge ratios satisfy the threshold value. In such an instance, processing may proceed from block 514 to block 520. At block 520, “Terminate Merging Operation,” the CPU 201 terminates the merging operation and none of the audio block groups are merged. The methods 500 may continue until none of the calculated merge ratios satisfy the threshold value. For example, once the merging occurs, the process of considering each possible merge group and merging the adjacent groups that yield the largest improvement is continued until no two adjacent groups can be merged to yield an improvement in coding accuracy. As there may be multiple candidates that satisfy the threshold value, considering each group before performing a merge provides for merging the groups resulting in the greatest amount of improvement.

In some instances, an MDCT transform is used to compute the spectral coefficients. In such an instance, the perceptual entropy PEₙₖ and bit count estimates G1ₙₖ, G2ₙₖ, Mₙₖ may be calculated for one block n and one band k using Equation 10:

$$P {E}_{n k} = {L}_{n k} * {log}_{2} ( 1.5 + 0.35 * {E}_{k} / {T}_{k} ) \qquad [ Equation 10 ]$$

$$where :$$

$${L}_{n k} = {f}_{n k} / ( {E}_{k}^{0.25} )$$

$${f}_{n k} = {\sum }_{b ∈ b a n d k} \sqrt{\vert {X}_{n b} \vert} ,$$

and where:
   Lₙₖ is the number of relevant lines for block n and band k;
   Eₖ is the average MDCT coefficient energy for all blocks in the group and band k;
   Tₖ is the mask threshold for band k averaged across all blocks in the group;
   fₙₖ is the form factor for block n and band k,
   b is the bin index of one MDCT spectral coefficient; and
X_{nb} is one MDCT coefficient in the set of all coefficients from block n and band k.
PEₙₖ is only calculated when Eₖ>Tₖ, otherwise PEₙₖ=0.

FIG. 5 provides only some example methods for calculating perceptual entropy. Other example methods of calculating perceptual entropy are appreciated in light of the present disclosure, and may be implemented herein.

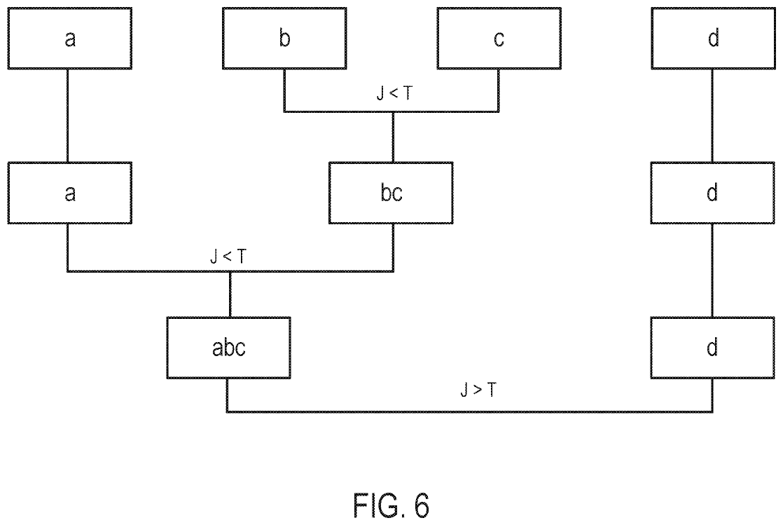

FIG. 6 illustrates an example of a Greedy Merge process applied to four blocks, according to various aspects of the present invention. The Greedy Merge process may be, for example, the methods 300, the methods 400, or the methods 500. In the example of FIG. 6, four blocks are initially arranged into four groups a, b, c, and d having one block each. The four groups a, b, c, and d are original block groups from the input audio data. Once the CPU 201 begins determining whether the block groups should be merged, the groups are candidate block groups. The method then finds (e.g., identifies or determines) that the two adjacent groups that should be merged, as determined using methods 400 or methods 500. In a first iteration, the method finds groups b and c should be merged, having a cost J less than a threshold T; therefore, groups b and c are merged into a new group to obtain three groups a, be, and d, where be is a merged group. In a second iteration, groups a, bc, and d are candidate groups. The described methods finds (e.g., identifies or determines) that adjacent groups a and be should be merged, having cost J less than a threshold T. Groups a and be are merged into a new group to give a total of two groups, abc and d. In a third iteration, the method finds (e.g., identifies or determines) that the cost J for the only remaining pair of groups is greater than the threshold T and the method terminates, leaving the final two groups abc and d.

FIG. 7 illustrates a flow chart of example methods 700 for decoding an encoded signal. The example method 700 may be performed by a processor such as, for example, CPU 201, which may be configured to perform method 700 via machine-executable instructions. The example method 700 may be broken into various blocks or partitions, such as blocks 702 and 704. The various process blocks illustrated in FIG. 7 provide examples of various methods disclosed herein, and it is understood that some blocks may be removed, added, combined, or modified without departing from the spirit of the present disclosure. For some examples, processing of the various blocks, which may be described as processes, methods, steps, blocks, operations, or functions, may commence at block 702.

At block 702, “Receive Encoded Signal Including Merged Blocks of Audio Information”, the CPU 201 receives an encoded signal including merged blocks of audio information. The blocks of audio information were merged based on a first measure of quality and a second measure of quality, as previously described. Processing may continue from block 702 to block 704.

At block 704, “Decode the Encoded Signal”, the CPU 201 decodes the encoded signal. In some instances, the decoded signal specifies the grouping of block groups that was calculated during encoding in grouping information (provided as metadata). Accordingly, the decoder reconstructs the audio information by un-grouping the merged groups based on the grouping information. In some instances, to reconstruct the audio information, scale factors are decoded from the encoded signal and are applied to the spectral coefficients.

A person skilled in the art realizes that the present invention by no means is limited to the embodiments described above. On the contrary, many modifications and variations are possible and considered within the scope of the appended claims. Various aspects and implementations of the present disclosure may also be appreciated from the following enumerated example embodiments (EEEs), which are not claims, and which may represent systems, methods, and devices, all arranged in accordance with aspects of the present disclosure.

EEE1. A method to encode blocks of audio in frames, wherein each frame includes a set of block groups, and wherein each block includes content, the method comprising: receiving an input signal that includes the blocks of audio information, wherein the blocks of audio information include a set of block groups for a respective frame; obtaining, for each block group in the set of block groups, a first measure of quality, wherein the first measure of quality indicates a cost associated with a merge of two or more blocks of audio information to form the respective block group; obtaining, for each respective block group, a second measure of quality, wherein the second measure of quality indicates an estimated distortion associated with a merge of two or more blocks of audio information to form the respective block group; merging, based on the first measure of quality and the second measure of quality, at least two block groups of the set of block groups to generate an encoded signal that represents contents of the input signal and associated control parameters for each block group in the set; and outputting the encoded signal.

EEE2. The method according to EEE1, wherein the steps of obtaining, for each respective block group, a first measure of quality and obtaining, for each respective block group, a second measure of quality include: in a first loop, selecting each block group from the set of block groups, in turn, as a selected first block group for a potential merge; and in a second loop, selecting each block group from the set of block groups different from the selected first block group, in turn, as a selected second block group for the potential merge.

EEE3. The method according to EEE2, wherein the steps of obtaining, for each respective block group, a first measure of quality and obtaining, for each respective block group, a second measure of quality include: comparing the first and second measures of the second block group to prior iterations of the second loop to selectively identify the second block group as a merge candidate block.

EEE4. The method according to EEE3, wherein the steps of merging at least two block groups of the set of block groups to generate the encoded signal and outputting the encoded signal include: after the second loop has completed all iterations, selectively merging the selected first block group with the identified merge candidate block; and after the second loop has completed all iterations, outputting the encoded signal.

EEE5. A method to encode blocks of audio in frames, the method comprising: receiving an input signal that includes a set of block groups in a frame, where each block includes content; in a first loop, selecting each block group from the set of block groups, in turn, as a selected first block group for a potential merge; in a second loop, selecting each block group from the set of block groups different from the first block group, in turn, as a selected second block group for potential merge; obtaining a first measure of quality associated with a merge of the selected first block group with the selected second block group; obtaining a second measure of quality associated with the merge of the selected first block group with the selected second block group; comparing the first measure of quality and the second measure of quality of the second block group to prior iterations of the second loop to selectively identify the second block group as a merge candidate block; after the second loop has completed all iterations, selectively merging the selected first block group with the identified merge candidate block; after the second loop has completed all iterations, assembling the frame as an encoded signal and outputting the encoded signal.

EEE6. The method according to any one of EEE1 to EEE5, wherein obtaining the first measure of quality and obtaining the second measure of quality comprises: calculating a first total weighted dB cost of a first block group relative to not merging the first block group and a second block group; calculating a second total weighted dB cost of the second block group relative to not merging the first block group and the second block group; calculating the total weighted cost of a merged group relative to not merging the first block group and the second block group; and determining whether to merge the first block group and the second block group to form the merged group based on the first total weighted dB cost, the second total weighted dB cost, and the total weighted cost.

EEE7. The method according to EEE6, wherein determining whether to merge the first block group and the second block group comprises: calculating a merge ratio value based on the first total weighted dB cost, the second total weighted dB cost, and the total weighted cost; and comparing the merge ratio value to a threshold.

EEE8. The method according to EEE7, wherein the merge ratio value is based on bit count differences between side information bit counts of the first block group, the second block group, and the merged group.

EEE9. The method according to EEE6, wherein calculating the first total weighted dB cost is based on an average power level of each scale factor band and a per-block power-domain scale factor of each scale factor band.

EEE10. The method according to any one of EEE6 to EEE9, wherein the first block group and the second block group are adjacent block groups.

EEE11. The method according to any one of EEE1 to EEE5, wherein obtaining the first measure of quality and obtaining the second measure of quality comprises: calculating, using perceptual entropy, a first bit cost to send a first block group and a second block group separately relative to a baseline perceptual entropy; calculating, using perceptual entropy, a second bit cost to send the first block group and the second block group as a merged group relative to the baseline perceptual entropy; and calculating a cost difference between the first bit cost and the second bit cost.

EEE12. The method according to EEE11, further comprising: determining whether to merge the first block group and the second block group by comparing the cost difference to a threshold.

EEE13. The method according to any one of EEE1 to EEE12, wherein the blocks comprise time-domain samples of the audio.

EEE14. The method according to any one of EEE1 to EEE12, wherein the blocks comprise frequency-domain coefficients of the audio.

EEE15. The method according to any one of EEE5 to EEE14, further comprising: after the first loop has completed all iterations and after the second loop has completed all iterations, terminating the potential merge of the selected first block group and the selected second block group.

EEE16. An apparatus to encode blocks of audio information arranged in frames, where each frame includes a set of block groups, and where each block includes content, the apparatus comprising: an electronic processor configured to perform operations including the method according to any one of EEE5 to EEE15.

EEE17. A non-transitory computer-readable storage medium recording a program of instructions that is executable by a device to perform the method according to any one of EEE5 to EEE15.

EEE18. An apparatus to encode blocks of audio information arranged in frames, where each frame includes a set of block groups, and each block includes content, the apparatus comprising: an electronic processor configured to: receive an input signal that includes the blocks of audio information, wherein the blocks of audio information includes a set of block groups for a respective frame, obtain, for each respective block group, a first measure of quality, wherein the first measure of quality indicates a cost associated with a merge of two or more blocks of audio information to form the respective block group, obtain, for each respective block group, a second measure of quality, wherein the second measure of quality indicates an estimated distortion associated with a merge of the two or more blocks of audio information to form the respective block group, merge, based on the first measure of quality and the second measure of quality, at least two block groups of the set of block groups to generate an encoded signal that represents contents of the input signal and associated control parameters for each block group in the set, and output the encoded signal.

EEE19. The apparatus according to EEE18, wherein, to obtain the first measure of quality and obtaining the second measure of quality, the electronic processor is configured to: calculate a first total weighted dB cost of a first block group relative to not merging the first block group and a second block group, calculate a second total weighted dB cost of the second block group relative to not merging the first block group and the second block group, calculate the total weighted cost of a merged group relative to not merging the first block group and the second block group, and determine whether to merge the first block group and the second block group to form the merged group based on the first total weighted dB cost, the second total weighted dB cost, and the total weighted cost.

EEE20. The apparatus according to EEE19, wherein, to determine whether to merge the first block group and the second block group, the electronic processor is configured to: calculate a merge ratio value based on the first total weighted dB cost, the second total weighted dB cost, and the total weighted cost, and compare the merge ratio value to a threshold.

EEE21. The apparatus according to EEE20, wherein the merge ratio value is based on bit count differences between side information bit counts of the first block group, the second block group, and the merged group.

EEE22. The apparatus according to EEE19, wherein calculating the first total weighted dB cost is based on an energy of each scale factor band and a per-block power-domain scale factor of each scale factor band.

EEE23. The apparatus according to any one of EEE18 to EEE22, wherein the first block group and the second block group are adjacent block groups.

EEE24. The apparatus according to EEE18, wherein, to obtain the first measure of quality and obtaining the second measure of quality, the electronic processor is configured to: calculate, using perceptual entropy, a first bit cost to send a first block group and a second block group separately relative to a baseline perceptual entropy, calculate, using perceptual entropy, a second bit cost to send the first block group and the second block group as a merged group relative to the baseline perceptual entropy, and calculate a cost difference between the first bit cost and the second bit cost.

EEE25. The apparatus according to EEE24, wherein the electronic processor is configured to: determine whether to merge the first block group and the second block group by comparing the cost difference to a threshold.

EEE26. The apparatus according to any one of EEE18 to EEE25, wherein the blocks comprise time-domain samples of the audio.

EEE27. A non-transitory computer-readable storage medium recording a program of instructions that is executable by a device to perform a method to process blocks of audio information arranged in frames, the method comprising: receiving an input signal including the blocks of audio information, wherein the blocks of audio information includes a set of block groups for a respective frame; obtaining, for each respective block group, a first measure of quality, wherein the first measure of quality indicates a cost associated with a merge of two or more blocks of audio information to form the respective block group; obtaining, for each respective block group, a second measure of quality, wherein the second measure of quality indicates an estimated distortion associated with a merge the two or more blocks of audio information to form the respective block group; merging, based on the first measure of quality and the second measure of quality, at least two block groups of the set of block groups to generate an encoded signal representing contents of the input signal and associated control parameters for each block group in the set; and outputting the encoded signal.

EEE28. A method to encode blocks of audio in frames, the method comprising: receiving an input signal that includes a set of two or more audio block groups in a frame, where each block includes content; selecting, as merge candidates, one or more pairs of audio block groups from the frame; obtaining, for each merge candidate, a first measure of quality associated with a merge of the audio block groups; obtaining, for each merge candidate, a second measure of quality associated with a merge of the audio block groups; selecting, based on the first and second measures of quality, one pair of audio block groups from the merge candidates that yields the largest improvement in coding accuracy; merging the selected pair of audio block groups; and assembling the frame as an encoded signal and outputting the encoded signal.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be replaced amended, or omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method to encode blocks of audio in frames, where each frame includes a set of block groups, and where each block includes content, the method comprising:
receiving an input signal that includes the blocks of audio information, wherein the blocks of audio information include a set of block groups for a respective frame;
obtaining, for each respective block group, a first measure of quality, wherein the first measure of quality indicates a side information cost associated with a merge of two or more blocks of audio information to form the respective block group;
obtaining, for each respective block group, a second measure of quality, wherein the second measure of quality indicates an estimated distortion due to spectral coefficient quantization associated with a merge of two or more blocks of audio information to form the respective block group;
merging, based on the first measure of quality and the second measure of quality, at least two block groups of the set of block groups to generate an encoded signal that represents contents of the input signal and associated control parameters for each block group included in the merging; and
outputting the encoded signal.

2. The method of claim 1, wherein the steps of obtaining, for each respective block group, a first measure of quality and obtaining, for each respective block group, a second measure of quality include:
in a first loop, selecting each block group from the set of block groups, in turn, as a selected first block group for a potential merge; and
in a second loop, selecting each block group from the set of block groups different from the selected first block group, in turn, as a selected second block group for the potential merge.

3. The method of claim 2, wherein the steps of obtaining, for each respective block group, a first measure of quality and obtaining, for each respective block group, a second measure of quality include:
comparing the first and second measures of the second block group to prior iterations of the second loop to selectively identify the second block group as a merge candidate block.

4. The method of claim 3, wherein the steps of merging at least two block groups of the set of block groups to generate the encoded signal and outputting the encoded signal include:
after the second loop has completed all iterations, selectively merging the selected first block group with the identified merge candidate block; and
after the second loop has completed all iterations, outputting the encoded signal.

5. A method to encode blocks of audio in frames, the method comprising:
receiving an input signal that includes a set of block groups in a frame, where each block includes content;
in a first loop, selecting each block group from the set of block groups, in turn, as a selected first block group for a potential merge;
in a second loop, selecting each block group from the set of block groups different from the first block group, in turn, as a selected second block group for potential merge;
obtaining a first measure of quality associated with a merge of the selected first block group with the selected second block group, the first measure of quality being a measure of side information cost associated with the merge of the selected first block group with the selected second block group;
obtaining a second measure of quality associated with the merge of the selected first block group with the selected second block group, the second measure of quality being a measure of distortion due to spectral coefficient quantization associated with the merge of the selected first block group with the selected second block group;
comparing the first measure of quality and the second measure of quality of the second block group to prior iterations of the second loop to selectively identify the second block group as a merge candidate block;
after the second loop has completed all iterations, selectively merging the selected first block group with the identified merge candidate block; and
after the second loop has completed all iterations, assembling the frame as an encoded signal and outputting the encoded signal.

6. The method of claim 1, wherein obtaining the first measure of quality and obtaining the second measure of quality comprises:
calculating a first total weighted dB cost of a first block group relative to not merging the first block group and a second block group;
calculating a second total weighted dB cost of the second block group relative to not merging the first block group and the second block group;
calculating the total weighted cost of a merged group relative to not merging the first block group and the second block group; and
determining whether to merge the first block group and the second block group to form the merged group based on the first total weighted dB cost, the second total weighted dB cost, and the total weighted cost.

7. The method of claim 6, wherein determining whether to merge the first block group and the second block group comprises:
calculating a merge ratio value based on the first total weighted dB cost, the second total weighted dB cost, and the total weighted cost; and
comparing the merge ratio value to a threshold.

8. The method of claim 7, wherein the merge ratio value is based on bit count differences between side information bit counts of the first block group, the second block group, and the merged group.

9. The method of claim 6, wherein calculating the first total weighted dB cost is based on an average power level of each scale factor band and a per-block power-domain scale factor of each scale factor band.

10. The method of claim 6, wherein the first block group and the second block group are adjacent block groups.

11. The method of claim 1, wherein obtaining the first measure of quality and obtaining the second measure of quality comprises:
calculating, using perceptual entropy, a first bit cost to send a first block group and a second block group separately relative to a baseline perceptual entropy;
calculating, using perceptual entropy, a second bit cost to send the first block group and the second block group as a merged group relative to the baseline perceptual entropy; and
calculating a cost difference between the first bit cost and the second bit cost.

12. The method of claim 11, further comprising:
determining whether to merge the first block group and the second block group by comparing the cost difference to a threshold.

13. The method of any of claim 1, wherein the blocks comprise time-domain samples of the audio.

14. The method of claim 1, wherein the blocks comprise frequency-domain coefficients of the audio.

15. The method of claim 5, further comprising:
after the first loop has completed all iterations and after the second loop has completed all iterations, terminating the potential merge of the selected first block group and the selected second block group.

16. An apparatus to encode blocks of audio information arranged in frames, where each frame includes a set of block groups, and where each block includes content, the apparatus comprising:
an electronic processor configured to perform operations including the method of claim 5.

17. A non-transitory computer-readable storage medium recording a program of instructions that is executable by a device to perform the method of claim 5.

18. An apparatus to encode blocks of audio information arranged in frames, where each frame includes a set of block groups, and each block includes content, the apparatus comprising:
an electronic processor configured to:
receive an input signal that includes the blocks of audio information, wherein the blocks of audio information includes a set of block groups for a respective frame,
obtain, for each respective block group, a first measure of quality, wherein the first measure of quality indicates a side information cost associated with a merge of two or more blocks of audio information to form the respective block group,
obtain, for each respective block group, a second measure of quality, wherein the second measure of quality indicates an estimated distortion due to spectral coefficient quantization associated with a merge of the two or more blocks of audio information to form the respective block group,
merge, based on the first measure of quality and the second measure of quality, at least two block groups of the set of block groups to generate an encoded signal that represents contents of the input signal and associated control parameters for each block group in the set, and
output the encoded signal.

19. The apparatus of claim 18, wherein, to obtain the first measure of quality and obtaining the second measure of quality, the electronic processor is configured to:
calculate a first total weighted dB cost of a first block group relative to not merging the first block group and a second block group,
calculate a second total weighted dB cost of the second block group relative to not merging the first block group and the second block group,
calculate the total weighted cost of a merged group relative to not merging the first block group and the second block group, and
determine whether to merge the first block group and the second block group to form the merged group based on the first total weighted dB cost, the second total weighted dB cost, and the total weighted cost.

20. The apparatus of claim 19, wherein, to determine whether to merge the first block group and the second block group, the electronic processor is configured to:
calculate a merge ratio value based on the first total weighted dB cost, the second total weighted dB cost, and the total weighted cost, and
compare the merge ratio value to a threshold.

21. The apparatus of claim 20, wherein the merge ratio value is based on bit count differences between side information bit counts of the first block group, the second block group, and the merged group.

22. The apparatus of claim 19, wherein calculating the first total weighted dB cost is based on an energy of each scale factor band and a per-block power-domain scale factor of each scale factor band.

23. The apparatus of claim 18, wherein the first block group and the second block group are adjacent block groups.

24. The apparatus of claim 18, wherein, to obtain the first measure of quality and obtaining the second measure of quality, the electronic processor is configured to:
calculate, using perceptual entropy, a first bit cost to send a first block group and a second block group separately relative to a baseline perceptual entropy,
calculate, using perceptual entropy, a second bit cost to send the first block group and the second block group as a merged group relative to the baseline perceptual entropy, and
calculate a cost difference between the first bit cost and the second bit cost.

25. The apparatus of claim 24, wherein the electronic processor is configured to:
determine whether to merge the first block group and the second block group by comparing the cost difference to a threshold.

26. The apparatus of claim 18, wherein the blocks comprise time-domain samples of the audio.

27. A non-transitory computer-readable storage medium recording a program of instructions that is executable by a device to perform a method to process blocks of audio information arranged in frames, the method comprising:
receiving an input signal including the blocks of audio information, wherein the blocks of audio information includes a set of block groups for a respective frame;
obtaining, for each respective block group, a first measure of quality, wherein the first measure of quality indicates a side information cost associated with a merge of two or more blocks of audio information to form the respective block group;
obtaining, for each respective block group, a second measure of quality, wherein the second measure of quality indicates an estimated distortion due to spectral coefficient quantization associated with a merge the two or more blocks of audio information to form the respective block group;
merging, based on the first measure of quality and the second measure of quality, at least two block groups of the set of block groups to generate an encoded signal representing contents of the input signal and associated control parameters for each block group in the set; and
outputting the encoded signal.

28. A method to encode blocks of audio in frames, the method comprising:
receiving an input signal that includes a set of two or more audio block groups in a frame, where each block includes content;
selecting, as merge candidates, one or more pairs of audio block groups from the frame;
obtaining, for each merge candidate, a first measure of quality associated with a merge of the audio block groups, wherein the first measure of quality indicates a side information cost associated with the merge of the audio block groups;
obtaining, for each merge candidate, a second measure of quality associated with a merge of the audio block groups, wherein the second measure of quality indicates a distortion due to spectral coefficient quantization associated with the merge of the audio block groups;
selecting, based on the first and second measures of quality, one pair of audio block groups from the merge candidates that yields the largest improvement in coding accuracy;
merging the selected pair of audio block groups; and
assembling the frame as an encoded signal and outputting the encoded signal.
